(19) United States
(12) Patent Application Publication
(10) Pub. No.: US 2011/0024473 A1
(43) Pub. Date: Feb. 3, 2011

(54) CARGO BED EXTENSION

(76) Inventor: Alonzo Weiss, Tofield (CA)

Correspondence Address: James Ray & Associates, 2640 Pitcairn Road, Monroeville, PA, 15146, US

(21) Appl. No.: 12/840,823

(22) Filed: Jul. 21, 2010

Related U.S. Application Data
(60) Provisional application No. 61/229,932, filed on Jul. 30, 2009.

(51) Int. Cl. B60R 9/06

(52) U.S. Cl. 224/500; 224/531; 224/521

(57) ABSTRACT

An adjustable cargo support apparatus for use with vehicles having a hitch receiver socket includes an elongated arm engageable at one end thereof inside such hitch receiver socket, a dual sleeve member, a tee-shaped cargo support beam having a riser slidingly engageable inside one of the open-ended sleeves of the dual sleeve member, and at least one releasable position locking means for restraining movement of the sleeve relative to the elongated arm. The dual sleeve beam member further includes an elongated connecting beam, a first open-ended sleeve having a portion of a side wall fixedly attached to one end of the connecting beam at a predetermined angle, and a second open-ended sleeve fixedly attached at an opposing end of the connecting beam, wherein an axis of the second sleeve is substantially perpendicular to that of the first sleeve.

### CROSS REFERENCE TO RELATED APPLICATION

This patent application is related to and claims priority from U.S. Provisional Patent Application Ser. No. 61/229,932 filed Jul. 30, 2009.

### FIELD OF THE INVENTION

The present invention relates, in general, to attachments for vehicles and, more particularly, this invention relates to an apparatus connecting to a vehicle trailer hitch to enable carrying long loads.

### BACKGROUND OF THE INVENTION

Prior to the conception and development of the present invention, cars, truck, vans, and SUV's with a trailer hitch connection have had an assortment of attachments to supplement cargo carrying. Typically, however, these have platforms or cradles at a single fixed height and fixed length behind the vehicle.

The prior art teaches cargo-supporting devices with a limited range of adjustability. For example, Broad in U.S. Pat. No. 5,451,088 discloses a cargo-bed extender attaching to a hitch with limited vertical and horizontal adjustments, which are not independent of each other. Lengthening the Broad extender also raises it in height, which will often not be desirable. In addition, Broad is not adaptable to supporting a load at roof height.

Lane in U.S. Pat. No. 6,662,983 discloses a rack system attachable to the rear of a vehicle in a hitch socket. While Lane's apparatus offers significant vertical adjustment, there is very limited length variability. The same is true of the Bagley apparatus disclosed in U.S. Pat. No. 6,237,824. There are numerous other examples disclosing adjustable height cargo supports with 90-degree members.

### SUMMARY OF THE INVENTION

The present invention provides an adjustable cargo support apparatus for use with vehicles having a hitch receiver socket includes an elongated arm engageable at one end thereof inside such hitch receiver socket, a dual sleeve member, a tee-shaped cargo support beam having a riser slidingly engageable inside one of the open-ended sleeves, and at least one releasable position locking means for restraining movement of the sleeve relative to the elongated arm. The dual sleeve beam member further includes an elongated connecting beam, a first open-ended sleeve having a portion of a side wall fixedly attached to one end of the connecting beam at a predetermined angle, and a second open-ended sleeve fixedly attached at an opposing end of the connecting beam, wherein an axis of second sleeve is substantially perpendicular to that of the first sleeve.

In a preferred embodiment, the cargo support beam also has eyebolts adjacent each end.

### OBJECTS OF THE INVENTION

It is, therefore, one of the primary objects of the present invention to provide a very flexible apparatus for extending the cargo-carrying ability of vehicles.

Another object of the present invention is to provide an apparatus for supporting long loads on vehicles and adjustable in height and length.

Still another object of the present invention is to provide a support device connecting to a hitch receiver socket on vehicles but adjustable in height for supports loads partially supported by the vehicle roof.

Yet another object of the present invention is to provide a vehicle cargo extender that is compact and lightweight when not in use.

An additional object of the present invention is to provide a simple cargo support extender that is readily convertible from a low-profile support for beds to a high-profile support for supplementing support from vehicle roofs.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 provides a perspective view of the present invention connected to the back of a vehicle.

FIG. 2 is a perspective view showing the apparatus of the present invention being used to haul a lengthy load.

FIG. 3 provides an alternative perspective view of the present invention supporting a load extending out the rear cargo bay of an SUV.

FIG. 4 provides a perspective view of the present invention supporting a load partially on the roof of a vehicle.

FIG. 5 is an elevation view of a main member of the present invention.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures. For the purposes of the specification and claims herein, sleeve shall be taken to mean a structure enclosed by sidewalls around at least two-thirds of its periphery.

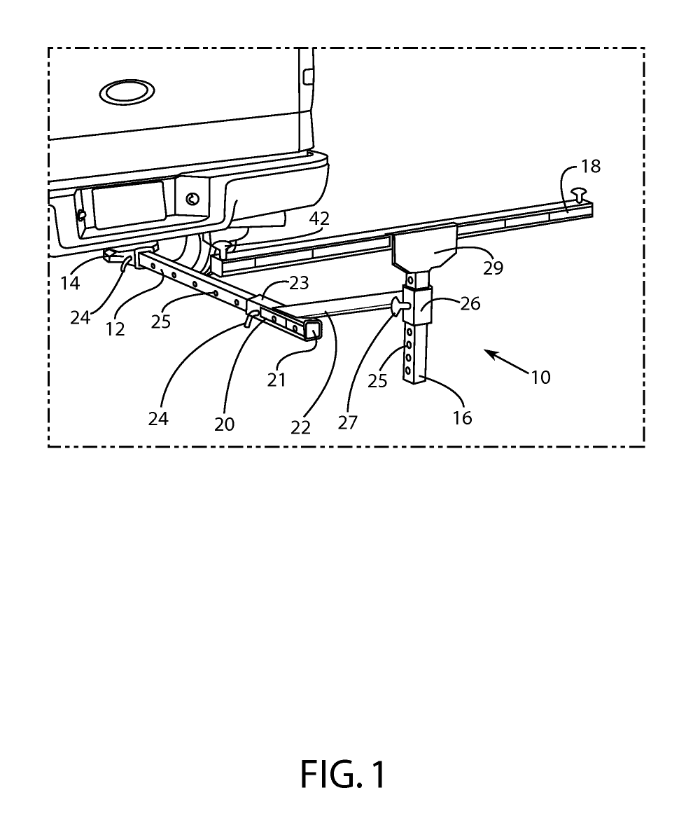

Referring initially to FIG. 1, a perspective view of the present invention, generally shown at 10, connected to the back of a vehicle is provided. The elongated horizontal extension arm 12 fits snugly into a square-end hitch socket 14, or alternatively outside, and the extension arm is approximately 4-ft long, and is typically a tubular steel member about 2-inches square with spaced-apart through apertures 25. A removable hitch pin 24 holds the proximal end of the extension arm 12 in the hitch socket 14, and a cotter pin or linchpin (not shown) commonly holds the hitch pins 24 in place. The elongated connecting beam 22 is secured at an angle of about 20-30 degrees to a portion of a side wall 23 of a first sleeve 20 with an open end 21 and, the sleeve 20 slidingly fits over the horizontal extension arm 12, both of which have apertures 25 which can be aligned for temporary locking in position with a hitch pin 24 when the apertures are aligned. The open back end 21 on the first sleeve 20 allows a wide extension range with adequate support. The sleeve will typically be a square-end tube, but could also be a 3-sided channel.

The opposing end of the connecting beam 22 is permanently fixed to a side portion of a second sleeve 26 with at least one aperture through both sides and engageable with a third hitch pin 24. While hitch pins are generally preferred, other methods of securing a relative position are acceptable, such as a threaded thumbscrew 27 in a threaded aperture in the side wall. The thumbscrew 27 may engage an aperture 25 on the inner member, or alternatively may have a sharp point to bite into the riser arm 16. The axes of the two sleeves 20 and 26 are generally perpendicular to each other. A vertical riser arm 16 with multiple apertures slidingly engages inside the second sleeve 26. Both the first and second sleeves are preferably square end tubes about 2.25 inches across the inside and open at both ends.

The upper end of the vertical riser arm 16 is irreversible fixed perpendicularly adjacent the center of the substantially horizontal cargo support beam 18. An optional gusset plate 29 may be welded onto both the riser arm and cargo tee to reinforce the joint. Eyebolts 42 at opposing ends serve the dual purpose of restraining loads from sliding off and connecting hold-down straps. The second sleeve 26 is preferably about 4 to 6 inches long, but longer and shorter dimensions are also acceptable. The hitch pins 24 are commonly ⅝-inch diameter.

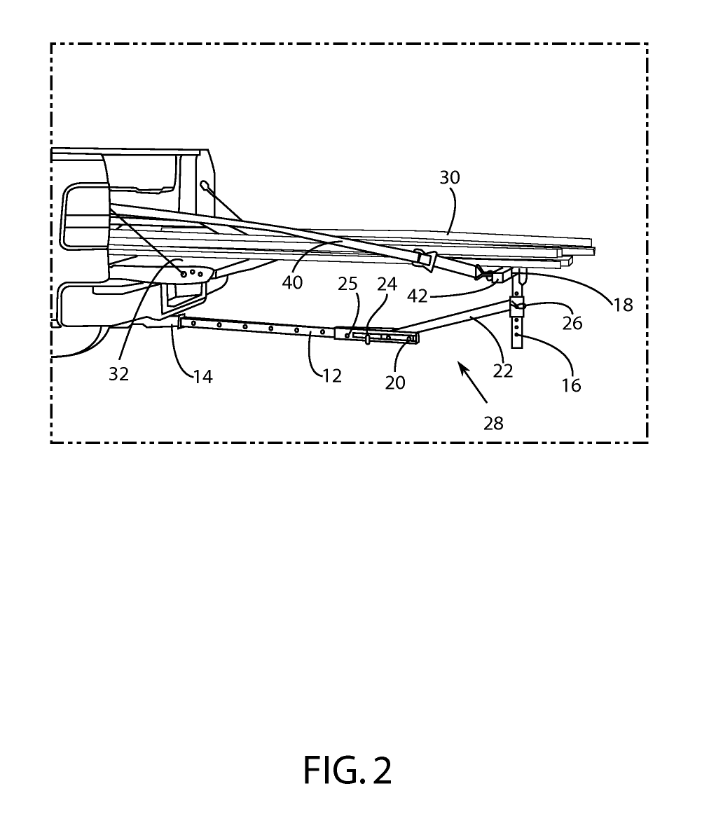

FIG. 2 is a perspective view showing the apparatus of the present invention being used to haul a lengthy load 30 out the back of a pickup truck bed 32 having a typical hitch receiver socket 14. The extension arm 12 is secured inside the receiver socket 14, and at the opposing end an open-ended first sleeve 20 slides over the extension arm until secured at the desired relative position by a hitch pin 24 through aligned apertures 25. The dual sleeve member 28 also includes the connecting beam 22 sloping upward from its attachment to the first sleeve, and is fixed at a second predetermined angle at the distal end to a second open-ended sleeve 26. A riser arm 16 slidingly engages inside the second sleeve 26 until fixed in position with a hitch pin or a threaded fastener as illustrated in FIG. 1. The horizontal cargo tee 18 is attached generally perpendicular to the riser arm 16, and the tee 18 will typically have an eyebolt or similar member 42 at each end for attaching straps 40 that aid in holding the cargo 30 in position.

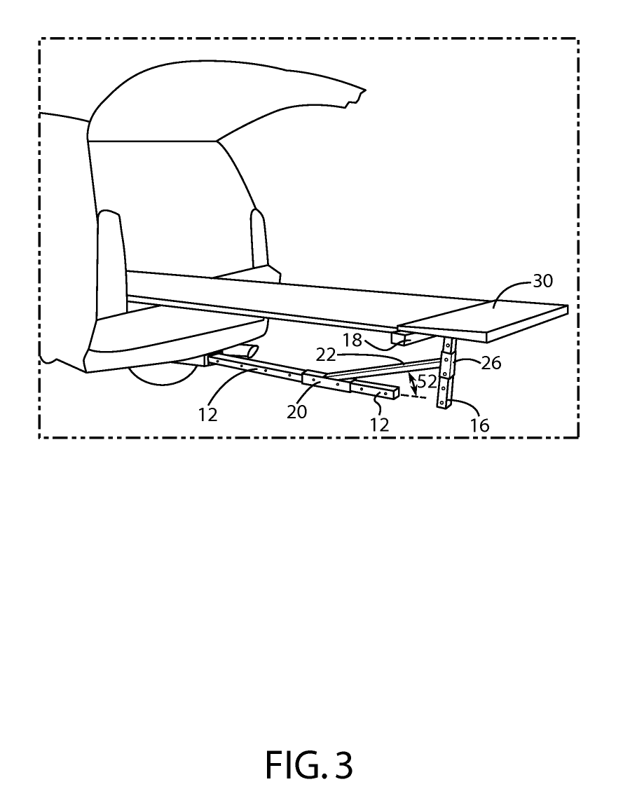

FIG. 3 provides an alternative perspective view of the present invention supporting a load 30 extending out the rear cargo bay of an SUV or van. The connecting beam 22 is permanently connected at the proximal end to a first sleeve 20 slidingly engaged with the extension arm 12, wherein the connecting beam 22 is at a predetermined angle 52 relative to the axis of the first sleeve 20 and elongated extension arm 12. Notice that the first sleeve 20 can slide all along the extension arm 12 to get a wide range of support length behind the vehicle. Attached to the distal end of beam 22 is a second open-ended sleeve 26, which supports the T-shaped cargo support beam 18 at the desired height. The significance of the angle 52, between the axis of the extension arm and the axis of the angle beam 22, being generally between 15 and 25 degrees is so that the cargo tee 18 can be positioned at essentially the same level as the cargo floor in the vehicle. If angle 52 is much greater than 30 degrees, then the cargo tee 18 is likely to be higher than the cargo floor no matter how close it is to the second sleeve 26.

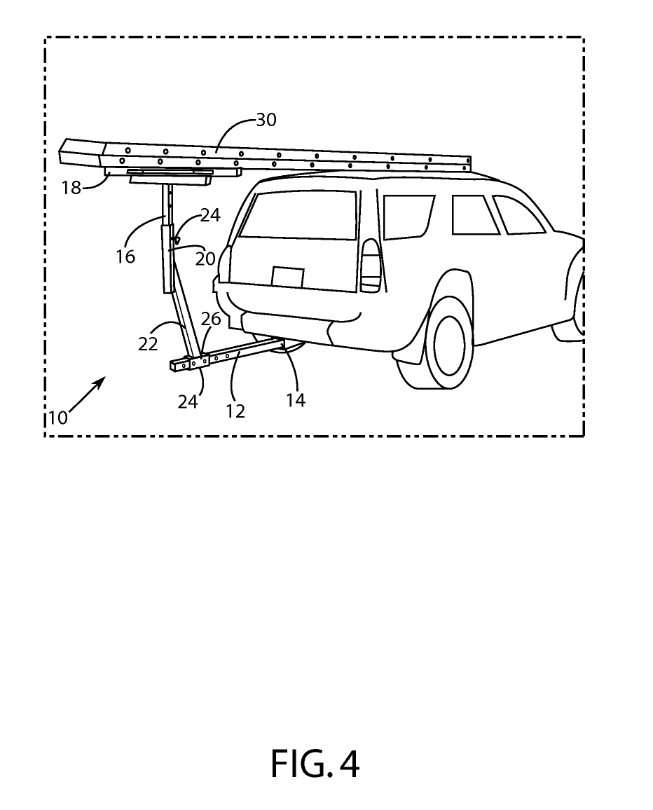

FIG. 4 provides a perspective view of the present invention, generally shown as 10, supporting a load 30 partially on the roof of a vehicle. The versatility of the present invention is illustrated wherein a simple reversal of locations for the first sleeve 20 and the second sleeve 26 greatly increases the height of the cargo tee 18. The second sleeve 26 is now slidingly engaged on the extension arm 12 which is inserted into the hitch receiver socket 14. The riser arm 16 is held at the desired position within the first sleeve 20 with a hitch pin 24.

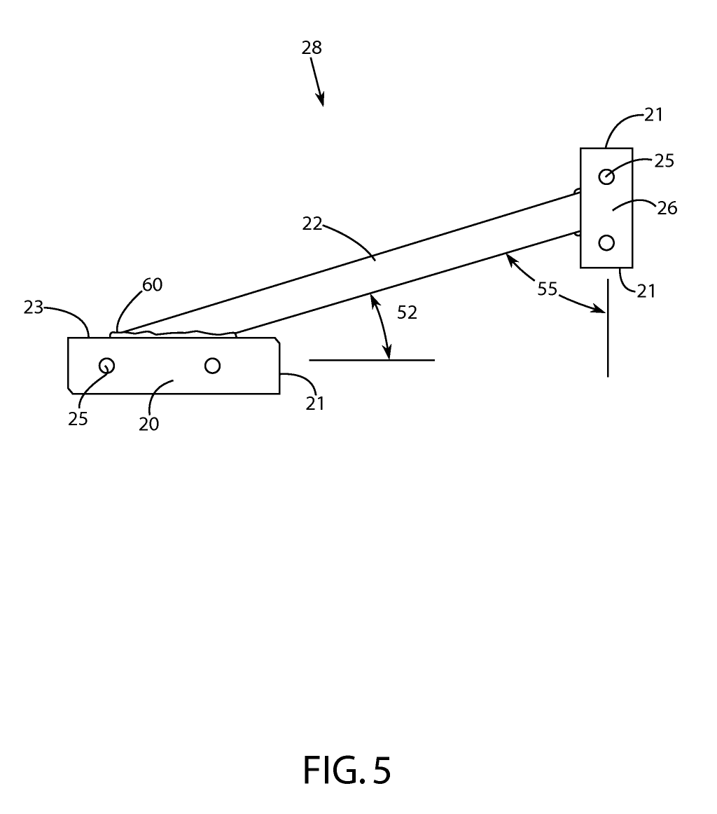

FIG. 5 is an elevation view of a main member of the present invention, the dual sleeve member 28. A first open-ended sleeve 20 is attached securely to one end of the elongated connecting beam 22 cut with a bevel to give a predetermined angle 52, preferably about 20 to 25 degrees from the axis of the first sleeve 20. This is a significant feature in that any angle steeper than 30 degrees will make it difficult to have the cargo tee at nearly the same height as the cargo bed. At an opposing end of the connecting beam 22, a second open-ended sleeve 26 is permanently fixed such that the axis of the second sleeve 26 is generally 90 degrees from that of the first sleeve, all three pieces being substantially in the same plane. The angle 55 will accordingly be 90 degrees minus that of angle 52. All pieces typically will be carbon steel square-end tubes permanently connected by welds 60 at the connections, preferably deep welds. Alternatively, the angle beam 22 may be solid or an I-beam and/or not square. The attachments to the sleeves may optionally be reinforced with braces. Both sleeves 20 and 26 have at least one aperture 25 through both sides perpendicular to the plane of the angle brace member 28. The sleeves each have two open ends 21 and side walls 23.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed is:

1. An adjustable cargo support apparatus for use with vehicles having a hitch receiver socket, said support apparatus comprising:
a) an elongated arm engageable at one end thereof at least one of outside or inside such hitch receiver socket;
b) a dual sleeve member, substantially in one plane, including:
(i) an elongated connecting beam;
(ii) a first open-ended sleeve having a side wall portion permanently fixed to one end of said connecting beam at a predetermined angle, said first sleeve being slidingly engageable over said elongated arm;
(iii) a second open-ended sleeve permanently fixed adjacent an opposing end of said elongated connecting beam, wherein an axis of said second sleeve is substantially perpendicular to that of said first sleeve;
c) a T-shaped cargo support beam having an elongated bar substantially perpendicular to said plane of said dual sleeve member and a riser arm slidingly engageable inside one of said open-ended sleeves; and
d) at least one releasable position locking means in said side wall portion of said first sleeve and engageable with said elongated arm for restraining movement of said first sleeve relative to said elongated arm.

2. The cargo support apparatus, according to claim 1, wherein said T-shaped cargo support beam further includes substantially vertical eyebolts adjacent ends of the support beam.

3. The cargo support apparatus, according to claim 1, wherein said elongated beam further includes a plurality of apertures alignable with at least one aperture in said sleeves.

4. An adjustable cargo support apparatus for use with vehicles having a hitch receiver socket, said support apparatus comprising:
a) an elongated arm engageable at one end thereof at least one of outside or inside such hitch receiver socket;
b) a dual sleeve member, substantially in one plane, including:
(i) an elongated connecting beam;
(ii) a first open-ended sleeve having a side wall portion permanently fixed to one end of said connecting beam at a predetermined angle, said second sleeve being slidingly engageable over said elongated arm;
(iii) a second open-ended sleeve permanently fixed adjacent an opposing end of said elongated connecting beam, wherein an axis of said second sleeve is substantially perpendicular to that of said first sleeve;
c) a T-shaped cargo support beam having an elongated bar substantially perpendicular to said plane of said dual sleeve member and a riser arm slidingly engageable inside said first open-ended sleeve; and
d) at least one releasable position locking means in said side wall portion of at least one of said sleeves and engageable with said elongated arm for restraining movement of said sleeves relative to said elongated arm.

5. The cargo support apparatus, according to claim 4, wherein said predetermined angle is between about 15 and 30 degrees.

6. The cargo support apparatus, according to claim 4, wherein said predetermined angle is between about 18 and 22 degrees.

7. The cargo support apparatus, according to claim 4, wherein said releasable position locking means is an angled hitch pin through aligned apertures in said elongated arm and said second sleeve.

8. The cargo support apparatus, according to claim 4, wherein said releasable position locking means is at least one threaded thumbscrew engageable with a threaded aperture in said side portions of said sleeves.

9. An adjustable cargo support apparatus for use with vehicles having a hitch receiver socket, said support apparatus comprising:
a) an elongated arm engageable at one end thereof at least one of outside or inside such hitch receiver socket;
b) a dual sleeve member, substantially in one plane, including:
(i) an elongated connecting beam;
(ii) a first open-ended sleeve having a side wall portion permanently fixed to one end of said connecting beam at a predetermined angle, said first sleeve being slidingly engageable over said elongated arm;
(iii) a second open-ended sleeve permanently fixed adjacent an opposing end of said elongated connecting beam, wherein an axis of said second sleeve is substantially perpendicular to that of said first sleeve;
c) a T-shaped cargo support beam having an elongated bar substantially perpendicular to said plane of said dual sleeve member and a riser arm slidingly engageable inside said second open-ended sleeve; and
d) at least one releasable position locking means in said side wall portion of said first sleeve and engageable with said elongated arm for restraining movement of said first sleeve relative to said elongated arm.

10. The cargo support apparatus, according to claim 9, wherein said predetermined angle is between about 15 and 30 degrees.
